(19) United States
(12) Patent Application Publication
(10) Pub. No.: US 2024/0204299 A1
(43) Pub. Date: Jun. 20, 2024

(54) ENERGY STORAGE THERMAL MANAGEMENT SYSYTEM

(71) Applicant: Sino-Brook New Energy Technology (Shanghai) Co., Ltd, Shanghai (CN)

(72) Inventors: Yunjian SONG, Shanghai (CN); Xuesong LIU, Shanghai (CN); Fujin FENG, Shanghai (CN); Fei ZHAO, Shanghai (CN); Zhiwang GUO, Shanghai (CN); Tong WANG, Shanghai (CN)

(73) Assignee: Sino-Brook New Energy Technology (Shanghai) Co., Ltd, Shanghai (CN)

(21) Appl. No.: 18/535,979

(22) Filed: Dec. 11, 2023

(30) Foreign Application Priority Data
Dec. 15, 2022 (CN) 202211618405.2
Dec. 15, 2022 (CN) 202211618418.X
Dec. 28, 2022 (CN) 202211693441.5
Jan. 10, 2023 (CN) 202320065988.4
Jan. 16, 2023 (CN) 202310074065.X
Jan. 16, 2023 (CN) 202310074671.1
Jan. 16, 2023 (CN) 202320141695.X
Nov. 15, 2023 (CN) 202311525551.5

(51) Int. Cl. H01M 10/6569; H01M 10/48; H01M 10/613; H01M 10/6563

(52) U.S. Cl. CPC H01M 10/6569; H01M 10/48; H01M 10/613; H01M 10/6563

(57) ABSTRACT

An energy storage thermal management system, comprising a refrigeration module and a cooling module, wherein the refrigeration module comprises an air-floating centrifugal compressor and a condenser. Wherein the air-floating centrifugal compressor is used for compressing a refrigerant to form a refrigerant in a first state, and an inlet of the condenser is connected to an exhaust port of the air-floating centrifugal compressor to cool down the refrigerant in the first state to form a refrigerant in a second state, and the temperature of the second state is lower than that of the first state but the pressure is the same. The cooling module is used for heat dissipation of the target equipment, and its inlet is connected with the outlet of the condenser, and its outlet is connected with the air inlet of the air-floating centrifugal compressor, and the inlet is arranged with a throttling element.

### CROSS-REFERENCE TO RELATED APPLICATION

This application claims the priority benefit of China application serial no. 202211618405.2, filed on Dec. 15, 2022, China application serial no. 202211618418.X, filed on Dec. 15, 2022, China application serial no. 202211693441.5, filed on Dec. 28, 2022, China application serial no. 202320065988.4, filed on Jan. 10, 2023, China application serial no. 202310074065.X, filed on Jan. 16, 2023, China application serial no. 202310074671.1, filed on Jan. 16, 2023, China application serial no. 202320141695.X, filed on Jan. 16, 2023, and China application serial no. 202311525551.5, filed on Nov. 15, 2023. The entirety of each of the above-mentioned patent applications is hereby incorporated by reference herein and made a part of this specification.

### BACKGROUND

### Technical Field

The present invention relates to the field of thermal management technology, and in particular to an energy storage thermal management system.

### Description of Related Art

Thermal management refers to the management and control of the temperature of a total system, discrete components, or their environments, with the aim of maintaining the normal operation of each component or improving their performance or lifetime. Currently, thermal management is usually required in fields such as electrochemical energy storage, and the thermal management has a significant impact on the performance, lifetime, and safety of energy storage systems. For energy storage batteries, they can use air-cooled or liquid-cooled mode.

Both air-cooled and liquid-cooled modes use refrigerants to exchange heat with the energy storage batteries through an intermediate medium. On the one hand, there is inevitably heat exchange loss in this way, which makes it difficult to meet the effect of rapid cooling for energy storage batteries with high charge-discharge rate. On the other hand, in the existing thermal management systems, the circulation of refrigerant is usually realized through traditional scroll or rotor compressors, which also has certain defects. Specifically, traditional scroll or rotor compressor assemblies typically have a large volume, and in some thermal management systems, two compressor refrigeration systems are even required for cooling. At the same time, the internal parts of the traditional scroll or rotor compressors have friction defects during operation, so the cleanliness of other parts in the system is required to be high, and the reliability of the system operation is poor. In addition, in order to improve reliability, traditional scroll or rotor compressors also need to use compressor oil for lubrication and sealing, which not only increases the cost of compressor oil, but also causes that the compressor oil is miscible with the refrigerant after entering the system, affecting the heat exchange of the refrigerant, which directly leads to a decrease in the system's refrigeration capacity by more than 5%.

Moreover, in most of the existing energy storage thermal management systems, a set of cooling device corresponds to a set of equipment to be cooled, so that a plurality of cooling devices need to be arranged for a plurality of sets of equipment to be cooled.

### SUMMARY

Aiming at some or all of the problems in the prior art, the present invention provides an energy storage thermal management system, comprising:
a refrigeration module, which is used for circulation of a refrigerant and comprises:
an air-floating centrifugal compressor, which is used to compress the refrigerant to form a refrigerant in a first state; and
a condenser, an inlet of which is connected to an exhaust port of the air-floating centrifugal compressor and which is configured to cool the refrigerant in the first state to form a refrigerant in a second state, and the temperature of the second state is lower than that of the first state, but the pressure is the same; and
a cooling module, the inlet of which is connected with the outlet of the condenser, the outlet of which is connected with the air inlet of the air-floating centrifugal compressor, and the inlet of the cooling module is arranged with a throttling element, the cooling module is used to dissipate heat from the target equipment.

Furthermore, the refrigeration module further comprises a bypass valve, and the bypass valve is connected between the air inlet and the exhaust port of the air-floating centrifugal compressor.

Furthermore, the refrigeration module further comprises:
an economizer, wherein its main circuit inlet is connected with an outlet of the condenser, and its main circuit outlet is connected with an inlet of the cooling module, and its auxiliary circuit outlet is connected to an air supplement inlet of the air-floating centrifugal compressor; and
an auxiliary throttling element, wherein its inlet is connected with the main circuit outlet of the economizer, and an outlet of the auxiliary throttling element is connected to an auxiliary circuit inlet of the economizer.

Furthermore, the cooling module comprises:
a first direct-cooling plate, which is arranged on the first side of the target equipment, and which comprises a first inlet and a first outlet, the first inlet is connected to the outlet of the condenser, and the first inlet is arranged with a first throttling element; and
a second direct-cooling plate, which is arranged on the second side opposite to the first side of the target equipment, and which comprises a second inlet and a second outlet, the second inlet is connected to the outlet of the condenser, and the second inlet is arranged with a second throttling element, wherein the fluid flow direction in the second direct-cooling plate is opposite to the fluid flow direction in the first direct-cooling plate.

Furthermore, the cooling module comprises an evaporator, which is arranged at the target equipment, the inlet of the evaporator is connected with the outlet of the condenser, and the outlet is connected with the air inlet of the air-floating centrifugal compressor, and the inlet of the evaporator is arranged with a throttling element.

Furthermore, the cooling module comprises:
a main circuit throttling element, which is connected to the outlet of the condenser; and
at least one evaporator, each evaporator is connected in parallel, each evaporator is arranged at a target equipment, and a branch circuit throttling element is respectively connected between the inlet of each evaporator and the main circuit throttling element, and the outlet of each evaporator is connected with the air inlet of the air-floating centrifugal compressor.

Furthermore, the cooling module comprises:
a coolant circuit, which is used to circulate coolant to cool the target equipment, and which comprises a water pump; and
an intermediate heat exchange device, which is connected with the refrigeration module and the coolant circuit respectively, so as to realize the heat exchange between the coolant and the refrigerant, so that the refrigerant is able to cool the coolant.

Furthermore, the coolant circuit comprises a plurality of coolant branches, each coolant branch is arranged in parallel, each coolant branch is configured to dissipate heat for a target device, and each coolant branch comprises a water pump, and the outlet of the water pump is connected to the intermediate heat exchange device through a one-way valve.

Furthermore, the throttling element comprises an electronic expansion valve.

Furthermore, the energy storage thermal management system further comprises at least one temperature sensor and at least one pressure sensor, and the temperature sensor and/or pressure sensor are arranged at the exhaust port, and/or the air outlet, and/or the air supplement inlet of the air-floating centrifugal compressor, and/or the inlet, and/or the outlet of the cooling module.

Furthermore, the energy storage thermal management system further comprises a first fan, which is arranged at the condenser, and which is used to introduce normal-temperature air into the condenser to achieve heat exchange.

Furthermore, the energy storage thermal management system further comprises a second fan, which is arranged at the evaporator.

Furthermore, the air-floating centrifugal compressor comprises:
a motor, which comprises:
a housing, wherein at two ends of its interior a first chamber and a second chamber are respectively arranged; and
a rotor, wherein an air-floating radial bearing is arranged on the rotor, the end of the rotor is arranged with a thrust disk, and one side or two sides of the thrust disk is arranged with an air-floating thrust bearing;
an impeller, which is arranged at the end of the rotor and located in the first chamber and/or the second chamber;
an air inlet, which is connected with the air inlet of the first chamber;
an exhaust port, which is connected with the air outlet of the second chamber;
a connecting pipe, the two ends of which are respectively connected with the air outlet of the first chamber and the air inlet of the second chamber; and
an air supplement inlet, which is arranged on the connecting pipe.

The present invention provides an energy storage thermal management system, which uses an electric high-speed air-floating centrifugal compressor as the core component of refrigerant circulation. Compared with the electric scroll compressor of the traditional automobile air-conditioning system, the electric high-speed air-floating centrifugal compressor is small in size, light in weight, without compressor oil, and the compressor and the system have high reliability, and the system refrigeration capacity is large. Specifically, the electric high-speed air-floating centrifugal compressor has no contact between the bearings and the motor shaft during operation, so the bearings are less worn and have a longer life. In addition, the electric high-speed air-floating centrifugal compressor is a high-speed permanent magnet synchronous motor, with high compressor power density, small volume and mass. At the same time, the internal circulation dynamic pressure air-floating bearings are used, which does not require additional air supplement pipelines, the structure is simple and reliable, and the intermediate pipe air supplement holes can be additionally set to facilitate the realization of the interstage cooling and reduce the power consumption of the compressor. In addition, the electric high-speed air-floating centrifugal compressor uses a closed impeller, and the inner wall surface of the pressure shell is equipped with sealing teeth, which can also reduce leakage and reflux losses, and further improve the aerodynamic efficiency of the compressor. Based on the electric high-speed air-floating centrifugal compressor, it can be matched with multiple different system scheme designs such as air-cooled, liquid-cooled, air supplement, bypass, multi-connected, centralized etc., and has a wide range of applications. Wherein, the structure of direct cooling of battery cells can effectively avoid the heat exchange loss of the traditional system and improve the energy efficiency of the system, and the upper and lower cold plates use the structure of opposite flow, which can better realize the temperature uniformity of the energy storage battery. In addition, setting a throttling element before the cooling module can also generate cooling capacity more quickly, so as to better meet the instantaneous heat dissipation needs of the energy storage batteries during rapid charging and discharging.

### BRIEF DESCRIPTION OF THE DRAWINGS

To further explain the above and other advantages and features of various embodiments of the present invention, more specific description of various embodiments of the present invention will be provided with reference to the accompanying drawings. It can be understood that these accompanying drawings depict only typical embodiments of the present invention, and therefore will not be considered as limiting their scope. In the accompanying drawings, identical or corresponding parts will be indicated by the same or similar reference numerals for the sake of clarity.

FIG. 1 illustrates a structural schematic diagram of an energy storage thermal management system according to an embodiment of the present invention;

FIG. 2 illustrates a structural schematic diagram of an energy storage battery according to an embodiment of the present invention;

FIG. 3 illustrates a structural schematic diagram of a direct-cooled energy storage thermal management system according to an embodiment of the present invention;

FIG. 4 illustrates a structural schematic diagram of an energy storage thermal management system using air-cooled scheme with bypass valves according to an embodiment of the present invention;

FIG. 5 illustrates a structural schematic diagram of an energy storage thermal management system using air-cooled scheme with bypass valves and air supplement structures according to an embodiment of the present invention;

FIG. 6 illustrates a structural schematic diagram of an energy storage thermal management system using basic multi-connected air-cooled scheme according to an embodiment of the present invention;

FIG. 7 illustrates a structural schematic diagram of an energy storage thermal management system using multi-connected air-cooled scheme with bypass valves according to an embodiment of the present invention;

FIG. 8 illustrates a structural schematic diagram of an energy storage thermal management system using multi-connected air-cooled scheme with bypass valves and air supplement structures according to an embodiment of the present invention;

FIG. 9 illustrates a structural schematic diagram of an energy storage thermal management system using basic liquid-cooled scheme according to an embodiment of the present invention;

FIG. 10 illustrates a structural schematic diagram of an energy storage thermal management system using liquid-cooled scheme with bypass valves according to an embodiment of the present invention;

FIG. 11 illustrates a structural schematic diagram of an energy storage thermal management system using liquid-cooled scheme with bypass valves and air supplement structures according to an embodiment of the present invention;

FIG. 12 illustrates a structural schematic diagram of an energy storage thermal management system using liquid-cooled scheme of multi-branch cold source with bypass valves according to an embodiment of the present invention;

FIG. 13 illustrates a structural schematic diagram of an energy storage thermal management system using liquid-cooled scheme of multi-branch cold source with bypass valves and air supplement structures according to an embodiment of the present invention; and

FIGS. 14A-14E illustrate structural schematic diagrams of the air flotation centrifugal compressor according to different embodiments of the present invention.

### List of Reference Numerals of Accompanying Drawings

100 Target equipment
001 Air-floating centrifugal compressor
002 Condenser
003 Cooling module
004 First fan
005 Throttling element
006 Bypass valve
007 Economizer
008 Auxiliary throttling element
200 Energy storage battery
201 Battery cells
202 First direct-cooling plate
203 Second direct-cooling plate
241 First throttling element
242 Second throttling element
401 Evaporator
402 Second fan
403 Branch circuit throttling element
901 Intermediate heat exchanger
902 Water pump
903 One-way valve
011 Air-bearing
012 Impeller
013 Rotor
014 Thrust disk
015 Thrust bearing

### DESCRIPTION OF THE EMBODIMENTS

In the following description, the present invention is described with reference to various embodiments. However, those skilled in the art will recognize that various embodiments can be implemented without one or more specific details or with other alternative and/or additional methods, materials, or components. In other situations, well-known structures, materials, or operations are not shown or described in detail so as not to obscure the inventive point of the present invention. Similarly, for the purpose of explanation, specific quantities, materials, and configurations are set forth in order to provide a comprehensive understanding of embodiments of the present invention. However, the present invention is not limited to these particular details. Furthermore, it should be understood that the embodiments illustrated in the accompanying drawings are illustrative representations and are not necessarily drawn to the correct scale.

In this specification, a reference to “an embodiment” or “the embodiment” means that particular feature, structure or characteristic described in connection with the embodiment are included in at least one embodiment of the present invention. The phrase “in one embodiment” appearing throughout this description may not necessarily all referring to the same embodiment.

Aiming at the shortcomings of the existing energy storage thermal management products, the present invention uses a high-speed air-floating centrifugal compressor to replace a scroll or rotor compressor, and uses the high-speed air-floating centrifugal compressor as the power source of the refrigerant circuit, and at the same time, it is matched with multiple different system scheme designs such as air-cooled, liquid-cooled, air supplement, bypass, multi-connected, centralized etc., to build a set of energy storage thermal management systems.

In embodiments of the present invention, throttling elements, comprising a first throttling element, a second throttling element, an auxiliary throttling element, a branch throttling element, etc., all refer to a device or element used to reduce gas pressure to achieve the purpose of evaporation, which may be, for example: an expansion valve, a capillary tube, a throttling tube, etc.

The specific scheme of the present invention will be further described below in conjunction with the accompanying drawings of the embodiments.

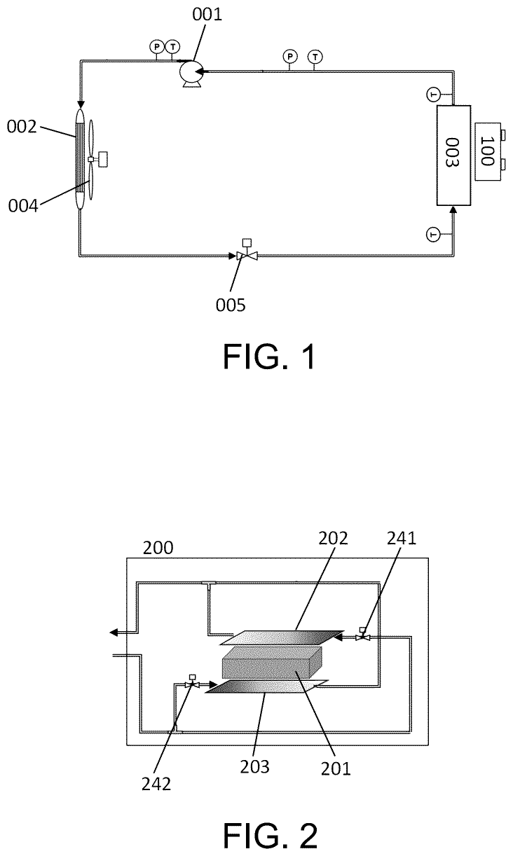

FIG. 1 illustrates a structural schematic diagram of an energy storage thermal management system according to an embodiment of the present invention. As shown in FIG. 1, the energy storage thermal management system comprises a refrigeration module and a cooling module 003. Wherein, the refrigeration module is used to provide thermal management for the target equipment 100, such as an energy storage battery, etc., specifically to provide compressed and condensed refrigerant in a cycle. The cooling module 003 then utilizes the condensed refrigerant to dissipate heat from the target equipment. As shown in FIG. 1, the refrigeration module comprises an air-floating centrifugal compressor 001 and a condenser 002. Wherein, the air inlet of the air-floating centrifugal compressor 001 is connected with the outlet of the cooling module 003, which is mainly used for compressing the refrigerant to form a refrigerant in the first state. The inlet of the condenser 002 is connected to the exhaust port of the air-floating centrifugal compressor 001, and the outlet is connected with the inlet of the cooling module 003 to be used for cooling down the refrigerant in the first state to form a refrigerant in the second state, and the temperature of the second state is lower than that of the first state, but the pressure is the same. As shown in FIG. 1, the high-temperature and low-pressure refrigerant after completing heat exchange with the target equipment 100 enters into the air-floating centrifugal compressor 001 for compression to form the refrigerant in the first state. In one embodiment of the present invention, in order to improve the refrigeration efficiency, a first fan 004 is also arranged at the fins of the condenser 002, and the first fan 004 introduces normal-temperature air into the fins of the condenser 002, so as to make the heat of the high-temperature refrigerant inside the condenser 002 to exchange heat with the air, and thus achieve the purpose of condensation.

When the energy storage thermal management system works, the refrigerant is compressed in a centrifugal way by the air-floating centrifugal compressor at first, the compressed high-temperature refrigerant reaches the condenser through the pipeline, and the fan sucks the normal-temperature air into the fins of the condenser, and the condenser exchange the heat of the internal high-temperature refrigerant with the air, and the condensed refrigerant reaches the throttling element 005, and the throttling element 005 throttles the refrigerant, the throttled refrigerant rapidly expands and evaporates. The refrigerant that has been throttled and expanded enters the cooling module 003 and carries out heat exchange with the target equipment 100, and the refrigerant absorbs the heat generated in the target equipment, so as to make the target equipment to drop to the expected temperature, to realize the effect of cooling, and the refrigerant after heat absorption returns to the air-floating centrifugal compressor 001 again.

In one embodiment of the present invention, a bypass valve 006 may also be arranged between the air inlet and the exhaust port of the air-floating centrifugal compressor 001. In this way, when the energy storage thermal management system works, if the bypass valve 006 is opened, then a small portion of high-temperature and high-pressure gas is throttled into low-temperature and low-pressure gases through the bypass valve 006 and flows to the air inlet of the air-floating centrifugal compressor, and merges with the compressor return gas of the system together and flows back into the air-floating centrifugal compressor 001.

In one embodiment of the present invention, the refrigeration module further comprises an air supplement component, the air supplement component comprises an economizer 007 and an auxiliary throttling element 008. Wherein, the economizer 007 comprises a main circuit inlet, a main circuit outlet, an auxiliary circuit inlet, and an auxiliary circuit outlet. Wherein, the main circuit inlet is connected with the outlet of the condenser 002, the main circuit outlet is connected with the inlet of the cooling module 003, the auxiliary circuit inlet is connected to the outlet of the auxiliary throttling element 008, and the auxiliary circuit outlet is connected to the air supplement inlet of the air-floating centrifugal compressor. The inlet of the auxiliary throttling element 008 is then connected with the main circuit outlet of the economizer 007. Then when the energy storage thermal management system works, high-temperature and high-pressure gas is discharged from the air-floating centrifugal compressor 001 and condensed into a high-temperature and high-pressure liquid in the condenser 002, and when it passes through the economizer 007, it will first carry out heat exchange with the refrigerant of the auxiliary circuit to further improve the supercooling degree, ensure that it is all liquid refrigerant, and meanwhile, a branch is re-introduced on the main circuit, and the high-temperature and high-pressure liquid will first passes through the auxiliary throttling element 008 to become a low-temperature and low-pressure liquid, and then carry out heat exchange with the refrigerant of the main circuit and evaporates through the auxiliary circuit of the economizer 007 to form a low-temperature and low-pressure gas and flows to the air supplement inlet of the air-floating centrifugal compressor, and the high-temperature and high-pressure liquid remaining in the main circuit is further throttled into the low-temperature and low-pressure liquid in the throttling element 005, and flows to the cooling module to dissipate heat of the target equipment to form the a high-temperature and low-pressure gas, and eventually flows back into the air-floating centrifugal compressor 001 to be compressed into a high-temperature and high-pressure gas, and a small portion of the high-temperature and low-pressure gas is throttled into a low-temperature and low-pressure gas when the bypass valve is opened, and flows to the air inlet of the air-floating centrifugal compressor 001, and merges with the compressor return gas of the system together and flows back into the air-floating centrifugal compressor 001.

As previously mentioned, the refrigeration module with the air-floating centrifugal compressor 001 as the core can be matched with multiple different cooling modules such as air-cooled, liquid-cooled, multi-connected, centralized modules, etc.

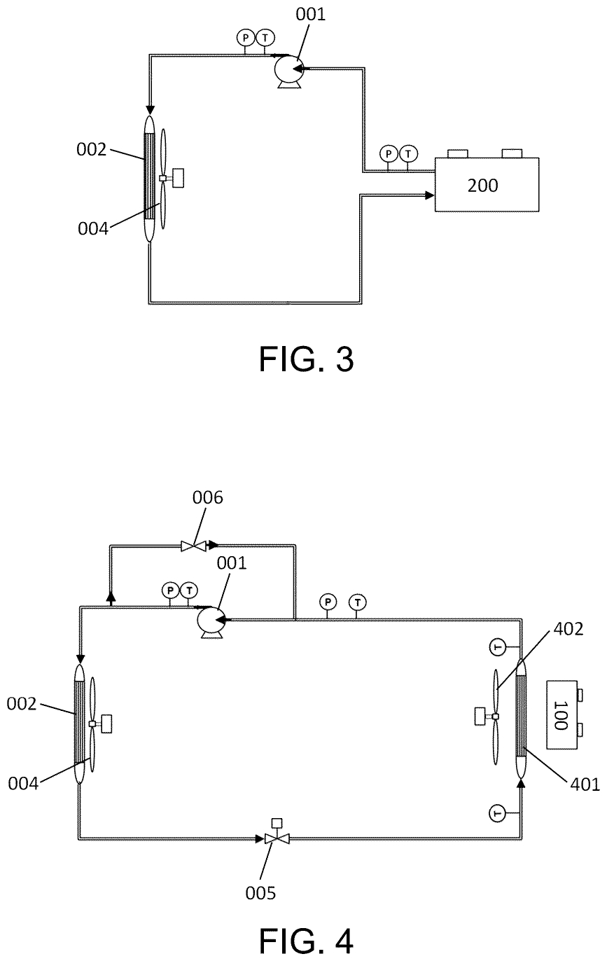

FIG. 2 illustrates a structural schematic diagram of an energy storage battery according to an embodiment of the present invention; and FIG. 3 illustrates a structural schematic diagram of a direct-cooled energy storage thermal management system applicable to the energy storage battery as shown in FIG. 2. As shown in the FIGS, an energy storage battery 200 comprises an battery core 201, a first direct-cooling plate 202, and a second direct-cooling plate 203. Wherein, the first direct-cooling plate 202 is arranged on the first surface of the battery cell 201 or at a certain distance from the first surface, and it comprises a first inlet and a first outlet, and as previously mentioned, the first inlet is connected with the outlet of the condenser 002, and a first throttling element 241 is further arranged at the first inlet in one embodiment of the present invention. The second direct-cooling plate 203 is arranged on the second surface of the battery cell 201 or at a certain distance from the second surface, wherein the second surface refers to a surface on the side opposite to the first surface. Similarly, the second direct-cooling plate 203 comprises a second inlet and a second outlet, the second inlet is connected with the outlet of the condenser 002, and as previously mentioned, in one embodiment of the present invention, a second throttling element 242 is further arranged at the second inlet. In order to avoid the problem of uneven heat dissipation of the energy storage battery, in one embodiment of the present invention, the energy storage battery uses a structure of reverse inlet and outlet of the upper and lower cooling plates, i.e. so that the fluid flow direction in the first direct-cooling plate 202 is opposite to that in the second direct-cooling plate 203. This can be achieved by setting the inlets and outlets of the first and second direct-cooling plates in completely opposite directions, i.e. the second outlet of the second direct-cooling plate is arranged on the same side as the first inlet of the first direct-cooling plate, and the second inlet is arranged on the same side as the first outlet. Meanwhile, inside the energy storage battery, the inflow refrigerant will be divided into multiple branches according to the number and arrangement of the battery core, and each branch will be equipped with a throttling element, such as an electronic expansion valve, etc., before it enters the direct-cooling plate, the opening of the electronic expansion valve will be adjusted automatically according to the heat dissipation needs of each battery core. It has been tested that by introducing the refrigerant directly into the energy storage battery through the direct-cooling plate, the refrigerant directly absorbs the heat generated by the battery core, which can increase the heat exchange efficiency by more than 5%.

In one embodiment of the present invention, the cooling module uses an air-cooled mode. Specifically, the cooling module comprises an evaporator 401, which is arranged at the target equipment 100, the inlet of the evaporator 401 is connected with the outlet of the condenser 002, and the outlet is connected with the air inlet of the air-floating centrifugal compressor 001, and a throttling element 005 is arranged at the inlet of the evaporator 401. The high-temperature and high-pressure liquid condensed from the condenser is throttled into a low-temperature and low-pressure liquid by the throttling element and then flows into the evaporator to evaporate into a low-temperature and low-pressure gaseous refrigerant, and carries out heat exchange with the target equipment to realize the heat dissipation of the target equipment, and then flows back into the air-floating centrifugal compressor to be compressed into a high-temperature and high-pressure gas. In one embodiment of the present invention, a second fan 402 may also be arranged at the evaporator.

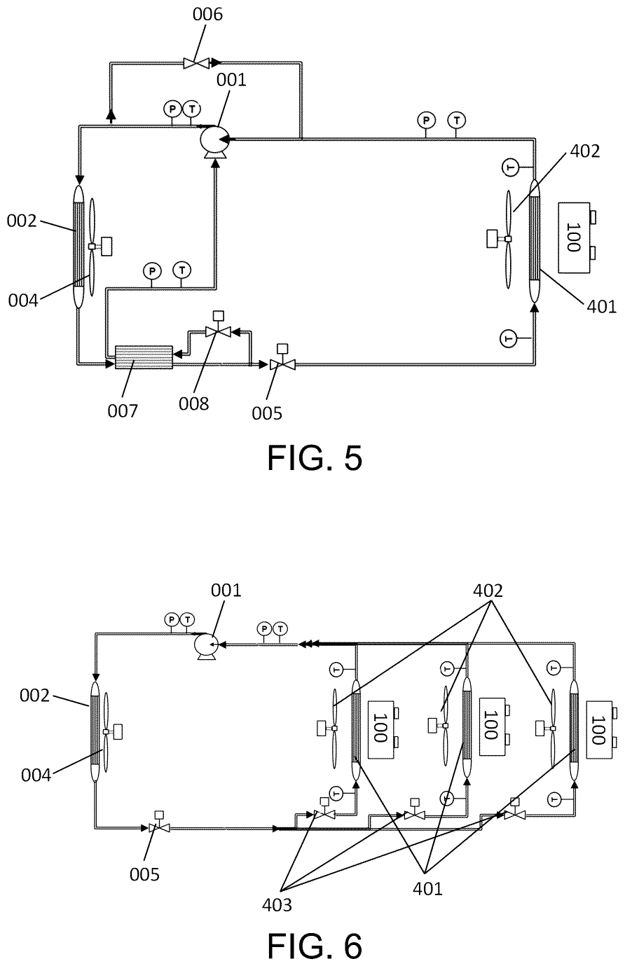

As previously mentioned, air supplement components and/or bypass valves may be added to the refrigeration module on the basis of the air-cooled mode. FIGS. 4 and 5 illustrate structural schematic diagrams of an energy storage thermal management system using air-cooled scheme with bypass valves, and an energy storage thermal management system using air-cooled scheme with bypass valves and air supplement structures, respectively, according to an embodiment of the present invention.

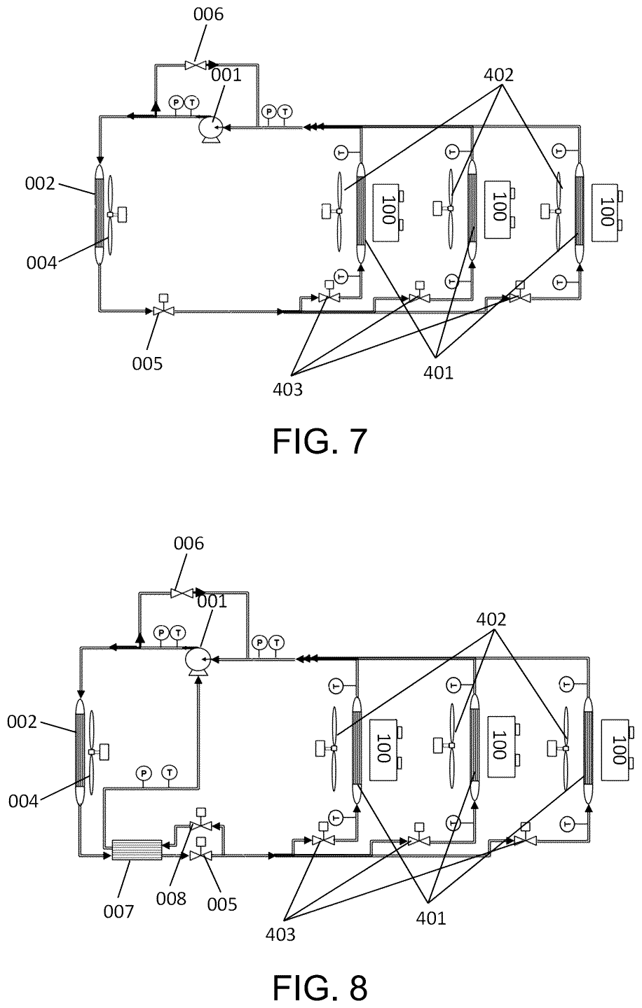

In one embodiment of the present invention, a multi-connected scheme may also be provided in the air-cooled mode, FIG. 6 illustrates a structural schematic diagram of an energy storage thermal management system using basic multi-connected air-cooled scheme according to an embodiment of the present invention. As shown in FIG. 6, in the multi-connected scheme, the cooling module comprises a main circuit throttling element 005 and a plurality of evaporators 401 arranged in parallel. Wherein the main circuit throttling element is connected to the outlet of the condenser, and each evaporator is arranged at a target equipment to dissipate heat of the target device, and a branch circuit throttling element 403 is respectively connected between the inlet of each evaporator and the main circuit throttling element, and the outlet of each evaporator is connected with the air inlet of the air-floating centrifugal compressor. Similarly, air supplement components and/or bypass valves may also be added to the refrigeration module on the basis of the multi-connected scheme. FIGS. 7 and 8 illustrate structural schematic diagram of an energy storage thermal management system using multi-connected air-cooled scheme with bypass valves, and an energy storage thermal management system using multi-connected air-cooled scheme with bypass valves and air supplement structures, respectively, according to an embodiment of the present invention.

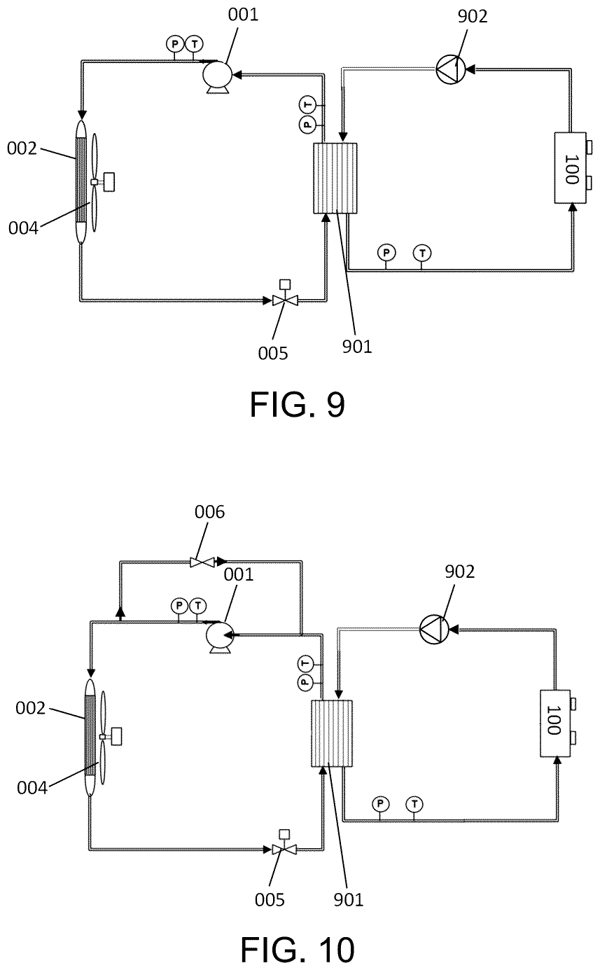

In one embodiment of the present invention, the cooling module uses a liquid-cooled mode. FIG. 9 illustrates a structural schematic diagram of an energy storage thermal management system using basic liquid-cooled scheme according to an embodiment of the present invention.

As shown in FIG. 9, when the liquid-cooled mode is used, the cooling module comprises a coolant circuit and an intermediate heat exchange device 901. Wherein the coolant circuit is used for the circulation of coolant to cool the target equipment and comprises a water pump 902. The intermediate heat exchange device is connected with the refrigeration module and the coolant circuit, respectively, in order to realize the heat exchange between the coolant and the refrigerant, so that the refrigerant can cool the coolant. As shown in FIG. 9, the inlet of the pump 902 is connected with the coolant outlet of the target equipment, and the outlet is connected to the cooling side inlet of the intermediate heat exchange device. The higher temperature coolant passing through the heat source of the target equipment carry out heat exchange with the refrigerant in the evaporator through the water pump to produce lower temperature coolant water, and then it can flow back into the heat source of the target equipment to re-dissipate and cool the high-temperature target equipment.

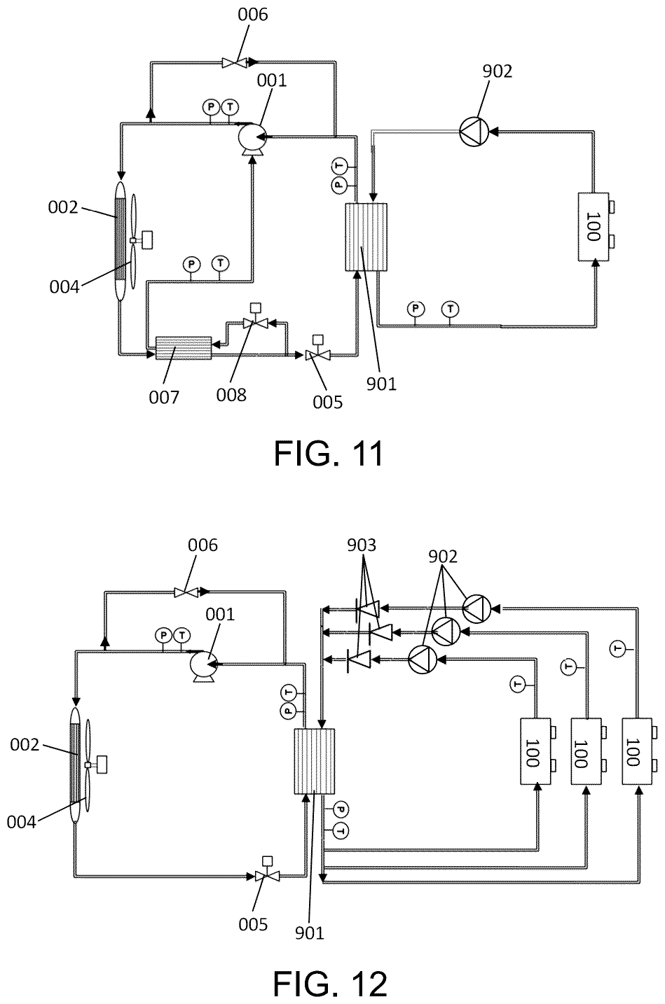

As previously mentioned, air supplement components and/or bypass valves may be added to the refrigeration module on the basis of the liquid-cooled mode. FIGS. 10 and 11 illustrate structural schematic diagrams of an energy storage thermal management system using liquid-cooled scheme with bypass valves, an energy storage thermal management system using liquid-cooled scheme with bypass valves and air supplement structures, respectively, according to an embodiment of the present invention.

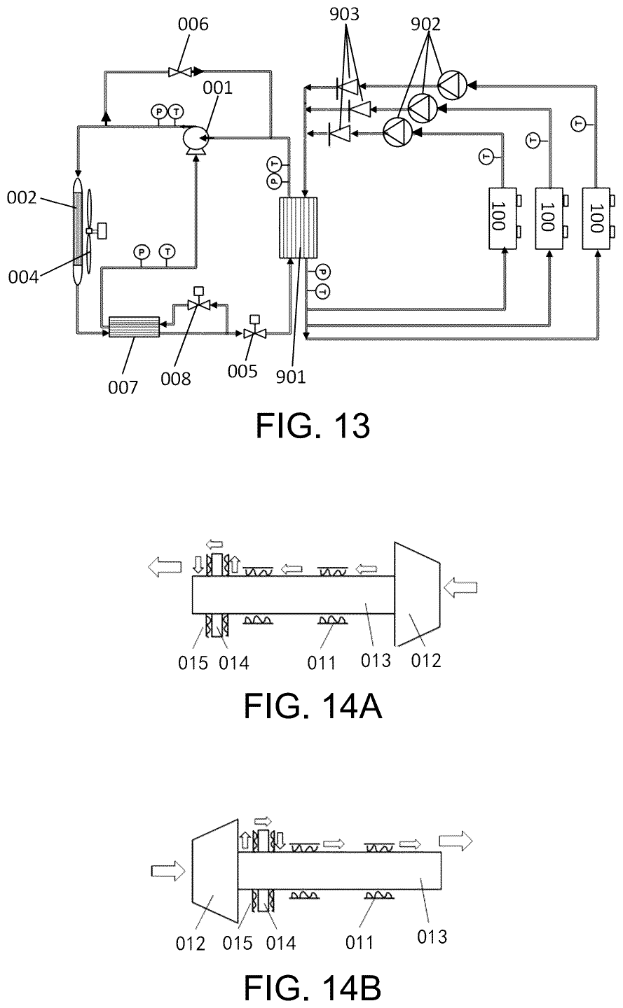

In one embodiment of the present invention, a multi-branch cold source scheme may also be provided in the liquid-cooled mode, i.e. the coolant circuit may comprises a plurality of coolant branches, each coolant branch is arranged in parallel, each coolant branch is used to dissipate heat from a target equipment, and each coolant branch comprises a water pump, and the outlet of the water pump is connected to the intermediate heat exchange device through a one-way valve 903. Similarly, air supplement components and/or bypass valves may also be added to the refrigeration module on the basis of a multi-branch cold source scheme. FIGS. 12 and 13 illustrate structural schematic diagrams of an energy storage thermal management system using liquid-cooled scheme of multi-branch cold source with bypass valves, and an energy storage thermal management system using liquid-cooled scheme of multi-branch cold source with bypass valves and air supplement structures, respectively, according to an embodiment of the present invention.

In order to calculate the cooling demand of the system and thus to control the operating state of various devices or modules, and protect the operation of the system, in one embodiment of the present invention, temperature sensors T and pressure sensors P are also arranged in the thermal management system. As shown in the FIG, the temperature sensors T and pressure sensors P can be may be arranged at, for example, the exhaust port, and/or the air outlet, and/or the air supplement inlet of the air-floating centrifugal compressor, and/or the inlet, and/or the outlet of the cooling module.

In one embodiment of the present invention, the air-floating centrifugal compressor 001 comprises a motor, an impeller, an air inlet, an exhaust port, and a connecting pipe. The motor comprises a rotor system, a stator, and a housing.

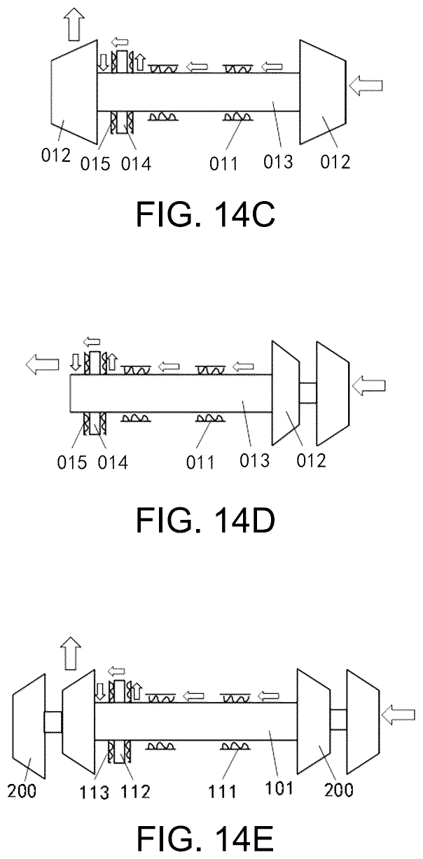

FIGS. 14A-14E illustrate structural schematic diagrams of the air flotation centrifugal compressor according to different embodiments of the present invention. As shown in the FIGS, the rotor system of the motor comprises radial air-bearings 011, when the rotating shaft of the motor rotates, the radial air-bearings inhale gas to form an air film to support the rotor rotating at a high speed, and at the same time the thrust bearings (if any) also form an air film, so that there is no contact between the thrust rotating shaft and the bearings, and the bearings are almost wear-free, and mechanical losses and noise can be substantially reduced or even eliminated. As shown in the FIGS, the impeller 012 is arranged at the end of the rotor 013 for compressing the low-temperature and low-pressure refrigerant gas from the evaporator to form high-temperature and high-pressure refrigerant gas to be discharged into the condenser. Herein, the terms “radial” and “axial” refer to the radial and axial directions of the rotor or its axis of rotation. In embodiments of the present invention, the rotor system 013 comprises two radial bearings, and the two radial bearings have a certain distance between them and can be symmetrically distributed on the rotor. In one embodiment of the present invention, the radial bearings use foil type dynamic pressure air-bearings, and an air film can be formed when gas is introduced into the bearing position, thus achieving the air-floating effect.

In order to withstand the axial thrust generated during the operation of the compressor, in one embodiment of the present invention, the rotor system is further provided with thrust disc 014 and thrust bearing 015. The thrust disc and the thrust bearing are optional. The thrust disc may be arranged at either end of the rotor, or a thrust disc may be arranged at each end of the rotor respectively. When only one thrust disc is arranged, a thrust bearing may be arranged on each side of the thrust disc respectively, the acting surfaces of the two thrust bearings are both oriented toward the thrust disc, and thus can respectively withstand axial thrust in different directions, specifically, the two thrust bearings can withstand axial thrust in opposite directions. When two thrust discs are arranged, one thrust bearing may be respectively arranged on two opposite sides of the two thrust discs, or on two sides far away from each other, the acting surfaces of the two thrust bearings are both oriented toward the thrust disc, and thus can respectively withstand axial thrust in different directions, specifically, the two thrust bearings can withstand axial thrust in opposite directions. In one embodiment of the present invention, the thrust bearings use foil type dynamic pressure air-bearings, an air film can be formed when gas is introduced into the bearing position, thus achieving the air-floating effect.

In addition, in different embodiments of the present invention, single-stage, double-stage or multi-stage impellers may be arranged according to actual needs. Specifically, when only a single-stage impeller is arranged, the impeller 012 may be arranged at either end of the rotor, then the side arranged with the impeller may be noted as the high-pressure side, and the side not arranged with the impeller is noted as the low-pressure side. When double-stage impellers are arranged, the two impellers may be respectively arranged at two ends of the rotor or all of them may be arranged at either end of the rotor, when respectively arranged at two ends of the rotor, the side arranged with the former-stage impeller may be noted as the low-pressure side, and the side arranged with the latter-stage impeller may be noted as the high-pressure side, and when all of them are arranged at one end of the rotor, the side arranged with the impellers is noted as the high-pressure side, and the side not arranged with the impeller is noted as the low-pressure side. Similarly, when multi-stage impellers are arranged, the multiple impellers can be equally or unequally arranged at two ends of the rotor respectively, or all can be arranged at either end of the rotor, when respectively arranged at two ends of the rotor, the side arranged with the former-stage impeller may be noted as the low-pressure side, and the side arranged with the latter-stage impeller may be noted as the high-pressure side, and when all of them are arranged at one end of the rotor, the side arranged with the impellers is noted as the high-pressure side, and the side not arranged with the impeller is noted as the low-pressure side. Based on this, as shown in the FIGS, when the rotor rotates, a portion of the high-pressure gas compressed by the impeller in the main gas path will enter the radial bearing on the high-pressure side under pressure, and then enter the radial bearing on the low-pressure side through the air gap between the stator and the rotor of the motor, and return to the main gas path. When a thrust disc and a thrust bearing are arranged, the high-pressure gas will also pass through the thrust bearing to form an air film to withstand axial thrust. In order to effectively reduce the axial thrust to which the thrust bearing is subjected, in one embodiment of the present invention, the impeller on the low-pressure side and the impeller on the high-pressure side are arranged in a back-to-back manner, so that the axial thrusts of the impellers on the high-pressure side and low-pressure side have opposite direction to offset each other. In one embodiment of the present invention, the impeller is a closed impeller. In one embodiment of the present invention, the impeller is fixed to the rotor by means of a lock nut.

A first chamber and a second chamber are respectively arranged at two ends of the interior of the housing, and the impellers are arranged in the first chamber and/or the second chamber. Wherein, the air inlet of the first chamber is connected to the air inlet of the compressor, which can also be understood that the air inlet is the air inlet of the first chamber. A connecting pipe is arranged between the first chamber and the second chamber, and the gas flows out from the air outlet of the first chamber into the connecting pipe, and then flows into the second chamber through the air inlet of the second chamber. The air outlet of the second chamber is connected to the exhaust port of the compressor, which can also be understood that the exhaust port is the air outlet of the second chamber. In one embodiment of the present invention, a first end cap and a second end cap are also arranged at the air outlets of the first chamber and the second chamber, respectively, and there are gaps between the first end cap and the second end cap on the one hand and the rotor and the impellers on the other hand, the gas can enter the air-bearing from the main gas path or return to the main gas path from the air-bearing through these gaps. In addition, pressure housings are respectively arranged at the outer sides of the two ends of the motor, and sealing rings are arranged between the pressure housings and the impellers, and the sealing rings can significantly reduce the backflow effect from the outlet to the inlet of the impellers, and further improve the efficiency of the compressor. In order to reduce the compression power consumption of the impeller, in one embodiment of the present invention, an interstage air supplement hole is also arranged on the connecting pipe to introduce the exhaust gas from the economizer to cool down the gas, and thereby achieve the purpose of reducing the compression power consumption of the high-pressure impeller and improving the efficiency of the system.

In one embodiment of the present invention, the opening and closing of the air-floating centrifugal compressor, and/or the opening degree of each throttling element, and/or the rotational speed of the fan, and/or the opening degree of the pump, and/or the bypass valve, the opening degree of the one-way valve, etc., can be controlled according to the temperature of the target equipment, and/or the pressure and the temperature of the gas entering the air-floating centrifugal compressor, and/or the pressure and the temperature of the gas discharged from the air-floating centrifugal compressor, and/or the pressure and the temperature of the coolant, etc., and thus ensure the quality of the thermal management.

Although the various embodiments of the present invention have been described above, however, it should be understood that they are presented only as examples and not as limitations. It will be apparent to those skilled in the art that various combinations, variations and changes can be made thereto without departing from the spirit and scope of the present invention. Therefore, the width and scope of the present invention disclosed herein should not be limited by the exemplary embodiments disclosed above, but should only be defined based on the accompanying claims and their equivalents.

What is claimed is:

1. An energy storage thermal management system, comprises:
a refrigeration module, is configured to circulate a refrigerant, wherein the refrigeration module comprises:
an air-floating centrifugal compressor, is configured to compress the refrigerant to form a refrigerant in a first state; and
a condenser, an inlet of the condenser is connected to an exhaust port of the air-floating centrifugal compressor and the condenser is configured to cool the refrigerant in the first state to form a refrigerant in a second state, and a temperature of the second state is lower than a temperature of the first state, but a pressure is the same; and
a cooling module, is configured to dissipate heat from at least one target equipment, wherein an inlet of the cooling module is connected with an outlet of the condenser, an outlet of the cooling module is connected with an air inlet of the air-floating centrifugal compressor, and the inlet of the cooling module is arranged with a throttling element.

2. The energy storage thermal management system according to claim 1, wherein the refrigeration module further comprises a bypass valve, and the bypass valve is connected between the air inlet and the exhaust port of the air-floating centrifugal compressor.

3. The energy storage thermal management system according to claim 2, wherein the refrigeration module further comprises:
an economizer, comprising a main circuit inlet is connected with the outlet of the condenser, a main circuit outlet is connected with the inlet of the cooling module, and an auxiliary circuit outlet is connected to an air supplement inlet of the air-floating centrifugal compressor; and
an auxiliary throttling element, wherein an inlet of the auxiliary throttling element is connected with the main circuit outlet of the economizer, and an outlet of the auxiliary throttling element is connected to an auxiliary circuit inlet of the economizer.

4. The energy storage thermal management system according to claim 1, wherein the cooling module comprises:
a first direct-cooling plate, is arranged on a first side of the at least one target equipment, and first direct-cooling plate comprises a first inlet and a first outlet, the first inlet is connected to the outlet of the condenser, and the first inlet is arranged with a first throttling element; and
a second direct-cooling plate, is arranged on a second side of the at least one target equipment opposite to the first side, and the second direct-cooling plate comprises a second inlet and a second outlet, the second inlet is connected to the outlet of the condenser, and the second inlet is arranged with a second throttling element, wherein a fluid flow direction in the second direct-cooling plate is configured to be opposite to a fluid flow direction in the first direct-cooling plate.

5. The energy storage thermal management system according to claim 1, wherein the cooling module comprises:
an evaporator, is arranged at the at least one target equipment, an inlet of the evaporator is connected with the outlet of the condenser, and an outlet of the evaporator is connected with the air inlet of the air-floating centrifugal compressor, and the inlet of the evaporator is arranged with a throttling element.

6. The energy storage thermal management system according to claim 1, wherein the cooling module comprises:
a main circuit throttling element, is connected to the outlet of the condenser; and
a plurality of evaporators, each the evaporator is connected in parallel, each the evaporator is arranged at one of the at least one target equipment, and a branch circuit throttling element is respectively connected between an inlet of each the evaporator and the main circuit throttling element, and an outlet of each the evaporator is connected with the air inlet of the air-floating centrifugal compressor.

7. The energy storage thermal management system according to claim 1, wherein the cooling module comprises:
a coolant circuit, is configured to circulate coolant to cool the at least one target equipment, and the coolant circuit comprises at least one water pump; and
an intermediate heat exchange device, is connected with the refrigeration module and the coolant circuit respectively, so as to realize a heat exchange between a coolant and a refrigerant, so that the refrigerant is able to cool the coolant.

8. The energy storage thermal management system according to claim 7, wherein the coolant circuit comprises a plurality of coolant branches, each the coolant branch is arranged in parallel, each the coolant branch is configured to dissipate heat for a target device, and each the coolant branch comprises one of the at least one water pump, and an outlet of the at least one water pump is connected to the intermediate heat exchange device through a one-way valve.

9. The energy storage thermal management system according to claim 1, wherein the throttling element comprises an electronic expansion valve.

10. The energy storage thermal management system according to claim 1, further comprises at least one temperature sensor and at least one pressure sensor, and the at least one temperature sensor and/or the at least one pressure sensor are arranged at the exhaust port, and/or the air inlet, and/or the air supplement inlet of the air-floating centrifugal compressor, and/or the inlet, and/or the outlet of the cooling module.

11. The energy storage thermal management system according to claim 1, further comprises a first fan, the first fan is arranged at the condenser, and the first fan is configured to introduce normal-temperature air into the condenser to achieve heat exchange.

12. The energy storage thermal management system according to claim 5, further comprises a second fan, the second fan is arranged at the evaporator.

13. The energy storage thermal management system according to claim 6, further comprises a second fan, the second fan is arranged at the evaporator.

14. The energy storage thermal management system according to claim 1, wherein the air-floating centrifugal compressor comprises:
a motor, comprises:
a housing, wherein a first chamber and a second chamber are respectively arranged at two ends in the housing; and
a rotor, wherein an air-floating radial bearing is arranged on the rotor, one end of the rotor is arranged with a thrust disk, and one side or two sides of the thrust disk is arranged with an air-floating thrust bearing;
an impeller, is arranged at one end of the rotor and located in the first chamber and/or the second chamber;
the air inlet, the air inlet of the air-floating centrifugal compressor is connected with an air inlet of the first chamber;
the exhaust port, the exhaust port of the air-floating centrifugal compressor is connected with an air outlet of the second chamber;
a connecting pipe, the two ends of the connecting pipe are respectively connected with an air outlet of the first chamber and an air inlet of the second chamber; and
an air supplement inlet, is arranged on the connecting pipe.
